(19) United States
(12) Patent Application Publication
(10) Pub. No.: US 2013/0207573 A1
(43) Pub. Date: Aug. 15, 2013

(54) SYNCHRONOUS CONTROL APPARATUS FOR SPEED-REDUCING DC MOTOR

(71) Applicant: LISONG LIU, GUANGZHOU CITY (CN)

(72) Inventor: LISONG LIU, GUANGZHOU CITY (CN)

(73) Assignee: CMECH (GUANGZHOU) INDUSTRIAL LTD.

(21) Appl. No.: 13/477,160

(22) Filed: May 22, 2012

(30) Foreign Application Priority Data
Feb. 10, 2012 (CN) 201210029441.5

(51) Int. Cl. H02K 7/116; H02P 7/18

(52) U.S. Cl. 318/10; 388/800

(57) ABSTRACT

The present invention relates to a synchronous control apparatus for speed-reducing DC motor, comprising a speed-reducing DC motor and a controller, wherein said speed-reducing DC motor comprises a motor and a speed reducer. Said speed-reducing motor is equipped with a speed detecting module to detect the actual rotational speed. Said controller is equipped with a storage unit to save reference rotational speed values. Said speed detecting module is linked to the controller which can vary the supply voltage to the speed-reducing DC motor while the actual rotational speed differs from the reference speed value.

### FIELD OF TECHNOLOGY

This invention relates to a DC motor control apparatus, more particularly, to a synchronous control apparatus for speed-reducing DC motors.

### BACKGROUND

DC motors have characteristics as simple structures, cost-efficiency, and are easy to manufacture and operate. DC motors are widely utilized in everyday life in products required moderate precision such as printers, scanners, and motorized curtains etc. The rotational speed of DC motors is dependent on its supply voltage. When the supply voltage remains constant, rotational speeds of different DC motors may be varied up to 20%. Rotational speed of DC motor is also changed as the load changes. Since DC motor has an open loop control system, the controller cannot detect the actual rotational speed of the motor shaft. In order to decrease the output speed, some merchandise mentioned above install speed reducer at the DC motor shaft, causing speed variation between the actual output speed to the desirable speed. For instant, when 12V is applied to a 12V DC motor, the maximum variation of rotational speed between different motors is approx. 20%. Such discrepancy will cause disparity in product properties from same model series, thereby impact product performance. One problem the user faced is that: when a plurality of motorized internal blinds sealed in double-glazing glass start to roll up or down simultaneously from the same level, the bottom rails will become uneven over time. The longer the running time, the greater the gap becomes, affecting visual appearance.

### SUMMARY

The present invention provides a synchronous control apparatus for speed-reducing DC motors. Said apparatus can improve speed controlling of speed-reducing DC motor and promote the actual speed to match with the predetermined speed as possible.

This invention relates to a synchronous control apparatus for speed-reducing DC motor, comprising a speed-reducing DC motor and a controller, wherein said speed-reducing DC motor comprises a motor and a speed reducer. Said speed-reducing motor is equipped with a speed detecting module to detect the actual rotational speed. Said controller is equipped with a storage unit to save up reference rotational speed values. Said speed detecting module is linked to the controller which can vary the supply voltage of the speed-reducing DC motor when the actual rotational speed doesn't match the reference speed.

Further, said speed detecting module comprises opaque fan blades on the motor shaft and detecting unit that can detect the positions of the blades. Said detecting unit is linked to the controller.

Furthermore, said detecting unit is an infrared sensor.

Furthermore, said motor shaft comprises a rear axle connected to the motor and a front axle connected to the speed reducer. Said fan blades are located on the front or rear axle.

Furthermore, the number of said fan blades can be 3, 4, 6, 8, 12 or 24, they are equally mounted around the periphery of the motor shaft.

In one of the embodiments, said speed detecting unit is an encoder linked to the controller.

Furthermore, a transmission mechanism connected with the front axle is provided to control the open-close motions of curtains.

Furthermore, the controller increases supply voltage to the speed-reducing DC motor when actual rotational speed is lower than the reference speed.

Furthermore, the controller decreases supply voltage to the speed-reducing DC motor when actual rotational speed is greater than the reference speed.

Compared to prior art, said invention is improved in the following aspects.

The speed-reducing DC motor is equipped with a speed detecting module which forms a closed loop with controller, such that the controller can monitor the actual rotational speed and regulate the supply voltage to the DC motor promptly, and improves speed control of the speed-reducing DC motor. By installing a storage unit in the controller to save up reference speed values, motor speed can be predetermined, at the meantime, the reference speed value can be provided for the feedback from the speed detecting module. With the usage of this synchronous control apparatus, synchronous motion control of multiple motorized curtains can be achieved.

### BRIEF DESCRIPTION OF THE DRAWINGS

FIG. 1 is a schematic diagram showing the structure of synchronous control apparatus for speed-reducing DC motor according to the present invention;

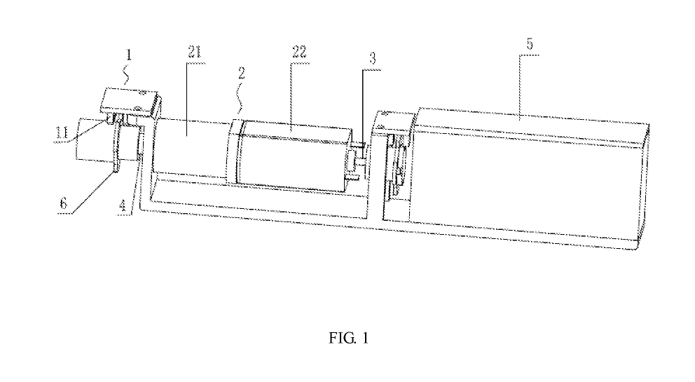

In FIG. 1,

1 is a speed detecting module;

11 is an infrared sensor;

2 is a speed-reducing DC motor;

21 is a speed reducer;

22 is a motor;

3 is a rear axle;

4 is a front axle;

5 is a controller

### DETAILED DESCRIPTION

Preferred embodiment of the present invention is described with reference to the figure as below.

As shown in FIG. 1, a synchronous control apparatus of speed-reducing DC motor comprises speed-reducing DC motor 2 and a controller 5, wherein said speed-reducing DC motor 2 is equipped with a speed detecting module 1 to monitor the actual rotational speed; Said controller 5 is equipped with a storage unit 1 in order to store reference rotational speed values, said speed detecting module 1 is linked to said controller 5. When the actual rotational speed of DC motor 2 differs from the predetermined reference speed, said controller 5 will modify the supply voltage to DC motor 2 accordingly. In this embodiment, said speed detecting module 1 comprises opaque fan 6 which is mounted on the motor shaft and a detecting unit for detecting the position of the fan blades. Said detecting unit is an opposite-type infrared sensor 11 linked to the controller 5. When the fan blade 6 crosses over the monitored area, the infrared sensor 11 sends pulse signals to controller 5 while infrared ray is blocked or unblocked by the fan blade 6.

Said motor shaft comprises the rear axle 3 connected to the motor 22 and the front axle 4 connected to the speed reducer 21. Said fan blades 6 are located on the front axle 4 or the rear axle 3, with its quantities of 3, 4, 6, 8, 12 or 24. Certainly, the number of fan blades may be varied if needed. Fan blades 6 are equally mounted around the periphery of the motor shaft. In this embodiment, four fan blades are chosen preferably. The width of the fan blade 6 equals to the spacing between blades. The blades, combined with fan blade spacing, equally divide a circle into 8 sections. Said fan blades 6 are located on the front axle 4 or the rear axle 3. The rotational speed of front axle 4 is n-fold to that of the rear axle, wherein n is the rotational ratio of speed reducer 21.

Based on the structure design and apparatus described above, practical application of the synchronous control apparatus of speed-reducing DC motor will be introduced in controlling of multiple motorized blinds as an example.

Before motorized blinds are shipped out of factory, manufacturers set up reference rotational speed into the storage unit in the controller. When synchronous control apparatus of the speed-reducing DC motor starts working, the rotation of motor 22 is outputted to the front axle 4 through the speed reducer 21, and the front axle 4 drives the a transmission mechanism which creates open/close motions of the blinds. In this process, infrared sensor 11 on the speed detecting module 1, which is blocked or unblocked by the fan blades 6, passes pulse signals onto controller 5. The actual rotational speed is calculated by counting the total pulse signals received by the controller 5 in a specific time. Controller 5 compares the actual rotational speed to the predetermined reference speed value saved in the storage unit. When the actual rotational speed is lower than the predetermined reference speed, controller 5 increases the supply voltage to speed-reducing DC motor 2 so as to increase the rotational speed of motor 22; When the actual rotational speed is greater than the predetermined reference speed, controller 5 decreases the supply voltage to speed-reducing DC motor 2 so as to decrease the rotational speed of motor 22. Through the above method, a closed-loop system is established between the controller 5 and the motor shaft, minimizing the discrepancy between the actual rotational speed of DC motor and the predetermined reference speed. Whenever the speed-reducing DC motor 2 stops, the number of its running cycles will be recorded by the controller 5. When operating a plurality of blinds, blinds should maintain uniform motions because the reference speeds in their controllers 5 are predetermined to be the same, and asynchronous movement can be avoided when up-down and left-right motions of the blinds occur. With a 12V DC motor, variation of rotational speeds of different motors can be sustained within 5% when the synchronous control apparatus is used. Aforementioned motorized blinds include vertical drapes, motorized roller blinds, motorized ceiling curtains (outdoor motorized awnings and indoor motorized blinds), motorized sun shade panels and motorized awnings etc, more specifically, including products such as Venetian blinds, roller blinds, Roman blinds, softness blinds, honeycomb blinds etc.

As a well-known technical solution among those skilled in the art, said speed detecting module 1 can be an encoder or Hall elements. The encoder or Hall elements are placed in motor 22 or external apparatus similar to present invention, and will be used to monitor the rotational speed of the motor 22. The detecting outcome will be passed onto the controller 5. This combination brings equivalent result as using fan 6 and the infrared sensor 11.

It's understood that what has been disclosed here is merely part of the preferred embodiments of present invention. Any embodiment derived from the technical proposal of present invention, in compliance with the technical guideline proposed above, or lack of any creative works from the skilled in the art, shall fall within the scope of protection of present invention.

What is claimed is:

1. A synchronous control apparatus for speed-reducing DC motor, comprising a speed-reducing DC motor and a controller, wherein said speed-reducing DC motor comprises a motor and a speed reducer, characterized in that said speed-reducing DC motor is equipped with a speed-detecting module for detecting the actual rotational speed; Said controller is equipped with a storage unit to store motor reference rotational speed values; Said speed-detecting module is linked to the controller which will vary the supply voltage to the speed-reducing DC motor while the actual rotational speed differs from the reference rotational speed value.

2. The synchronous control apparatus of the speed-reducing DC motor according to claim 1, wherein said speed-detecting module comprises opaque fan blades on the motor shaft and a detecting unit that can detect the positions of the blades, and said detecting unit is linked to the controller.

3. The synchronous control apparatus of the speed-reducing DC motor according to claim 2, wherein said detecting unit is an infrared sensor.

4. The synchronous control apparatus of the speed-reducing DC motor according to claim 3, wherein said motor shaft comprises a rear axle connected to the motor and a front axle connected to the speed reducer; Said blades are mounted on either the front axle or the rear axle.

5. The synchronous control apparatus of the speed-reducing DC motor according to claim 4, wherein the quantity of said blades is 3, 4, 6, 8, 12, or 24, which are evenly mounted around the periphery of the motor shaft.

6. The synchronous control apparatus of the speed-reducing DC motor according to claim 1, wherein said speed-detecting module is an encoder linked to the controller.

7. The synchronous control apparatus of the speed-reducing DC motor according to claim 1, wherein a transmission mechanism connected to the front axle controls the open and close motion of curtains.

8. The synchronous control apparatus of the speed-reducing DC motor according to claim 2, wherein a transmission mechanism connected to the front axle controls the open and close motion of curtains.

9. The synchronous control apparatus of the speed-reducing DC motor according to claim 3, wherein a transmission mechanism connected to the front axle controls the open and close motion of curtains.

10. The synchronous control apparatus of the speed-reducing DC motor according to claim 4, wherein a transmission mechanism connected to the front axle controls the open and close motion of curtains.

11. The synchronous control apparatus of the speed-reducing DC motor according to claim 5, wherein a transmission mechanism connected to the front axle controls the open and close motion of curtains.

12. The synchronous control apparatus of the speed-reducing DC motor according to claim 6, wherein a transmission mechanism connected to the front axle controls the open and close motion of curtains.

13. The synchronous control apparatus of the speed-reducing DC motor according to claim 1, wherein the controller increases the supply voltage to the speed-reducing DC motor while the actual rotational speed is lower than the reference speed value.

14. The synchronous control apparatus of the speed-reducing DC motor according to claim 2, wherein the controller increases the supply voltage to the speed-reducing DC motor while the actual rotational speed is lower than the reference speed value.

15. The synchronous control apparatus of the speed-reducing DC motor according to claim 3, wherein the controller increases the supply voltage to the speed-reducing DC motor while the actual rotational speed is lower than the reference speed value.

16. The synchronous control apparatus of the speed-reducing DC motor according to claim 6, wherein the controller increases the supply voltage to the speed-reducing DC motor while the actual rotational speed is lower than the reference speed value.

17. The synchronous control apparatus of the speed-reducing DC motor according to claim 1, wherein the controller decreases the supply voltage to the speed-reducing DC motor while the actual rotational speed is higher than the reference speed value.

18. The synchronous control apparatus of the speed-reducing DC motor according to claim 2, wherein the controller decreases the supply voltage to the speed-reducing DC motor while the actual rotational speed is higher than the reference speed value.

19. The synchronous control apparatus of the speed-reducing DC motor according to claim 3, wherein the controller decreases the supply voltage to the speed-reducing DC motor while the actual rotational speed is higher than the reference speed value.

20. The synchronous control apparatus of the speed-reducing DC motor according to claim 6, wherein the controller decreases the supply voltage to the speed-reducing DC motor while the actual rotational speed is higher than the reference speed value.
